(19) United States
(12) Patent Application Publication
(10) Pub. No.: US 2002/0090014 A1
(43) Pub. Date: Jul. 11, 2002

(54) Optical module assembling method, optical module and optical module assembling apparatus

(75) Inventor: Tomohisa Ishimaru, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 09/985,005

(22) Filed: Nov. 1, 2001

(30) Foreign Application Priority Data
Nov. 2, 2000 (JP) 2000-336431

(51) Int. Cl. H01S 3/04

(52) U.S. Cl. 372/36

(57) ABSTRACT

The present invention provides a method of assembling an optical module in which a first carrier on which a semiconductor laser element is fixedly mounted and a second carrier on which a photodiode is fixedly mounted are fixedly soldered on a base. This method has a step of applying a solder onto the base; a step of placing the first and second carriers on the base; a step of heating the solder and photographing the heated solder; a step of detecting the fused state of the solder from the image data of the photographed solder; and a step of scrubbing the first or second carrier based on the detected state of the fused solder.

### BACKGROUND OF THE INVENTION

The present invention relates to a method of assembling an optical module used in the field of optical communication and so on, such as a semiconductor laser module, an optical module and an apparatus for assembling an optical module.

In recent years, semiconductor laser elements have broadly been used as a signal light source or an excitation light source for optical fiber amplifiers in the optical communication. In the case a semiconductor laser module is used as a signal light source or an excitation light source in the optical communication, it is often used as a semiconductor laser module for optically coupling the laser beam outputted from the semiconductor laser module with the optical fiber.

FIG. 3 is a side cross-sectional view of a semiconductor laser module relating to its internal structure while FIG. 4 is a perspective view illustrating such a state that a first carrier, second carrier, first lens and optical isolator are mounted on a base.

Referring to FIGS. 3 and 4, the semiconductor laser module 40 comprises a hermetically sealed package 1, a semiconductor laser element 2 located within the package 1 for outputting a laser beam, a first carrier 3 on which the semiconductor laser element 2 is fixedly mounted, an optical fiber 3 for receiving the laser beam from the semiconductor laser element 2, a photodiode 5 for receiving a monitoring laser beam outputted from the back facet (left side in FIG. 3) of the semiconductor laser element 2, a second carrier 6 on which the photodiode 5 is fixedly mounted, and a base 7 on which the first and second carriers 3, 6 are fixedly mounted through soldering. The base 7 is of a substantially L-shaped cross-section and formed of Cu—W alloy or the like.

In front of the semiconductor laser element 2 (right side in FIG. 3), a first lens 8 for collimating the laser beam from the semiconductor laser element 2 is located on the base 7. The first lens 8 is firmly fitted and held into an aperture 9a of a first lens holder 9 which is formed of stainless steel or the like (see FIG. 4). The first lens holder 9 is held by a first holding member 10 on the base 7.

In front of the first lens 8, there is located an optical isolator 11 for regulating the direction of beam passage. The optical isolator 11 is held by a second holding member 12 (see FIG. 4). There is also a case wherein the optical isolator 11 is omitted.

The package 1 includes a flange 1a formed thereon at one side. The flange 1a includes a window 13 for receiving the laser beam after it has passed through the optical isolator 11 and a second lens 14 for condensing the laser beam. The second lens 14 is held by a third holding member 15.

The third holding member 15 fixedly supports a slide ring 16 at one end, which is YAG laser welded to the third holding member 15 after the slide ring 16 has properly been positioned in a plane perpendicular to the optical axis of the optical fiber 4 (X-Y plane).

The optical fiber 4 is held by a ferrule 17 which is fixedly mounted in the slide ring 16 through YAG laser welding. Thus, the optical fiber 4 can be positioned at its proper position in the direction of optical axis (Z-axis) of the optical fiber 4.

The base 7 is fixedly mounted on a cooling device 18 which is fixedly mounted on the internal base of the package 1. The cooling device 18 is to cool the semiconductor laser element 2 and consists of Peltier device. The raised temperature due to heat from the semiconductor laser element 2 is sensed by a thermistor 19 (see FIG. 4) on the first carrier 3. The cooling device 18 is so controlled that the temperature sensed by the thermistor 19 can be maintained constant. Thus, the laser output of the semiconductor laser element 2 can be stabilized.

The laser beam outputted from the front facet of the semiconductor laser element 2 is collimated by the first lens 8 and condensed by the second lens 14 into the optical fiber 4 through the window 13. The condensed laser beam is then externally delivered through the optical fiber 4.

On the other hand, the monitoring laser beam outputted from the back facet of the semiconductor laser element 2 is received by the photodiode 5. By calculating the amount of received beam at the photodiode 5, the optical output of the semiconductor laser element 2 and the like can be regulated.

### SUMMARY OF THE INVENTION

The present invention provides a method of assembling an optical module comprising a carrier on which an optical element is fixedly mounted and a base on which said carrier is fixedly soldered, comprising the steps of:

depositing a solder on said base;

placing said carrier on said solder;

heating and photographing said solder;

detecting the state of fused solder from the image data of said photographed solder; and

scrubbing said carrier based on the detected state of the fused solder.

The present invention also provides an optical module comprising a carrier on which an optical element is fixedly mounted and a base on which said carrier is fixedly soldered, said optical module being made by:

depositing a solder on said base;

placing said carrier on said solder;

heating and photographing said solder;

detecting the state of fused solder from the image data of said photographed solder; and

scrubbing said carrier based on the detected state of the fused solder.

The present invention further an apparatus for assembling an optical module comprising a carrier on which an optical element is fixedly mounted and a base on which said carrier is fixedly soldered, comprising:

a heating section for heating a solder on said base;

a photographing section for photographing the solder on said base;

a scrubbing section for scrubbing the carrier on which the optical element is fixedly mounted in the fused state of the solder on said base; and

a detecting section for detecting the state of the fused solder from the image data of the solder photographed by said photographing section.

### BRIEF DESCRIPTION OF THE DRAWINGS

FIG. 1 is a side view illustrating a method of assembling a semiconductor laser module according to the present invention.

FIG. 2 is a top view further illustrating the same method.

FIG. 3 is a side cross-sectional view of a semiconductor laser module relating to its internal structure.

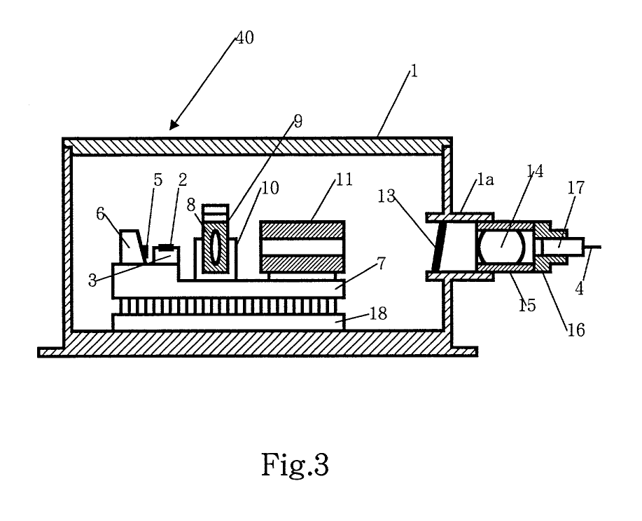

FIG. 4 is a perspective view of a base on which a first carrier, second carrier, first lens and optical isolator are mounted.

FIG. 5 illustrates a related art method of fixedly mounting first and second carriers on a base through soldering in a semiconductor laser module assembling process.

### DETAILED DESCRIPTION

An embodiment of the present invention will now be described in comparison with the related art with reference to the drawings.

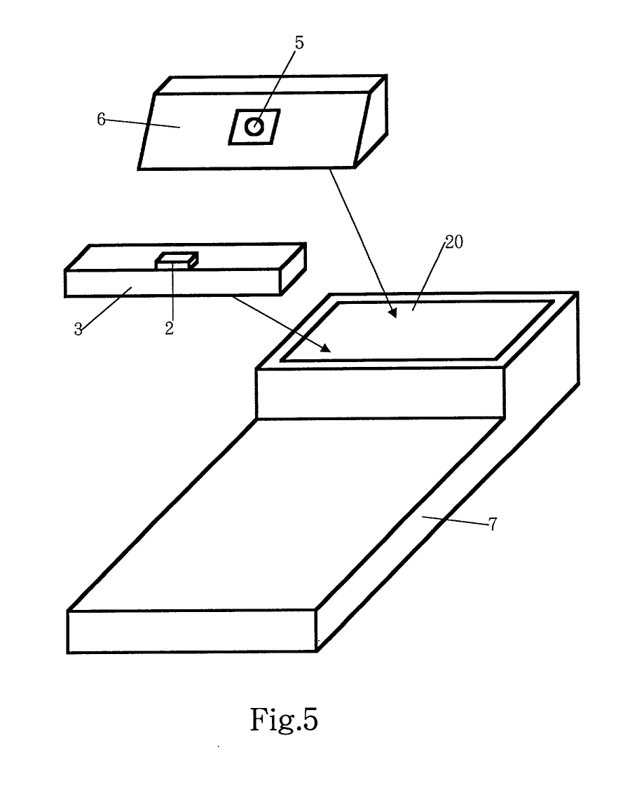

FIG. 5 illustrates a related art method of fixedly mounting first and second carriers 3, 6 on a base 7 through soldering in a process of assembling a semiconductor laser module 40.

A semiconductor laser element 2 is fixedly mounted on the first carrier 3 in place while a photodiode 5 is fixedly mounted on the second carrier 6 in place.

The bottoms of the first and second carriers 3, 6 which are to be bonded to the base 7 are plated with Au. The top of the base 7 is also plated with Au.

A solder 20 such as Au—Sn or the like is supplied onto the top of the base 7.

Next, the first and second carriers 3, 6 are properly positioned and contacted on the base 7. Thereafter, the solder 20 is heated and fused by a heater at a predetermined temperature.

Next, the first and second carriers 3, 6 are scrubbed to remove the oxide film on the solder 20 and the first and second carriers 3, 6 are positioned at proper places. After that, the solder 20 is solidified to fix the components to the base 7

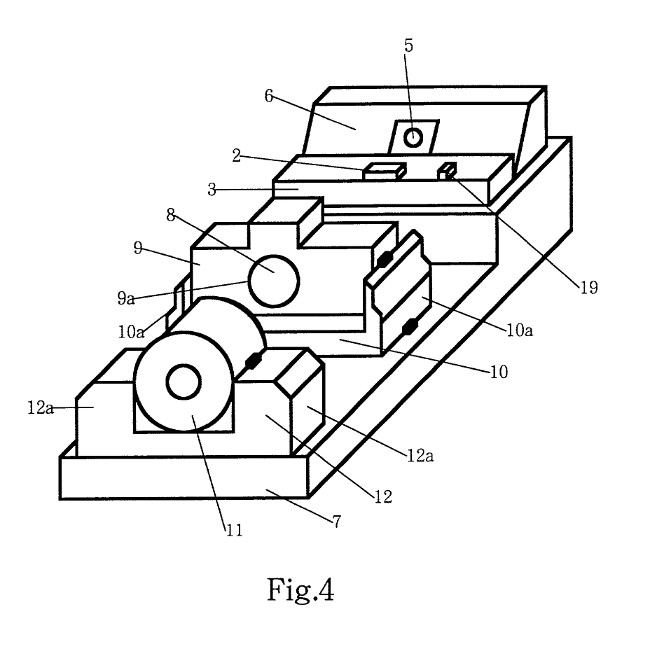

Next, a first lens 8 for collimating the laser beam emitted from the semiconductor laser element 2 is fixedly positioned on the top of the base 7. At this time, as shown in FIG. 4, a first lens holder 9 for holding the first lens 8 is interposed between a pair of first holding portions 10a in a first holding member 10. The first holding member 10 and first lens holder 9 are then moved such that the laser beam will be collimated in the desired manner. Thereafter, the first holding member 10 is fixed to the base 7 through YAG laser welding. Subsequently, the first lens holder 9 is fixed to the first holding member 10 through YAG laser welding.

The optical isolator 11 (if being used) is fixedly mounted on the base 7 in front of the first lens 8. At this time, as shown in FIG. 4, the optical isolator 11 is interposed between a pair of second holding portions 12a in a second holding member 12 located on the base 7. After aligned, the optical isolator 11 is fixedly mounted on the base 7 through YAG laser welding.

The base 7, on which the first carrier 3, second carrier 6, first lens 8 and optical isolator 11 are mounted, is then mounted on a cooling device 18 located within the package 1. The base 7 is electrically connected with leads (not shown) in the package 1 through gold wires (not shown) and optically coupled with the optical fiber 4 through the second lens 14.

When the first and second carriers 3, 6 are to be soldered on the base 7, the related art fused the solder 20 after the base 7 had been placed on a heating device (not shown). The heating of the solder 20 by the heating device was carried out for a predetermined time irrespectively of the actual fused state of the solder 20.

Since the transfer of heat from the heating device to the base 7 is variable, the scrubbing may not be carried out since the solder 20 is not sufficiently fused even when it is heated up to a set temperature. On the contrary, the solder 20 may perfectly be fused until the temperature thereof reaches the set temperature. This may vary the composition of the solder 20 lowering the melting point of the solder. In this case, the solder 20 is solidified before the scrubbing process is initiated. So, the scrubbing process and the positioning process for components can't be good. For example, where the components are to be soldered onto the Au-plated base 7 through the Au—Sn solder 20, Au will diffuse from the Au plating after time passage counted when the solder 20 is initially fused. This abruptly increases the melting point in the solder. This raises a problem in that the solder 20 is prematurely fused.

In this case time counted from the fusing of the solder 20 to the scrubbing process is too long, the time loss in the manufacturing task occurs.

On the contrary, the present invention provides an optical module assembling method, an optical module and an optical module assembling apparatus which can carry out the scrubbing at an optimal timing by detecting the state of fused solder through an image processing, thereby reducing the time loss in manufacturing task.

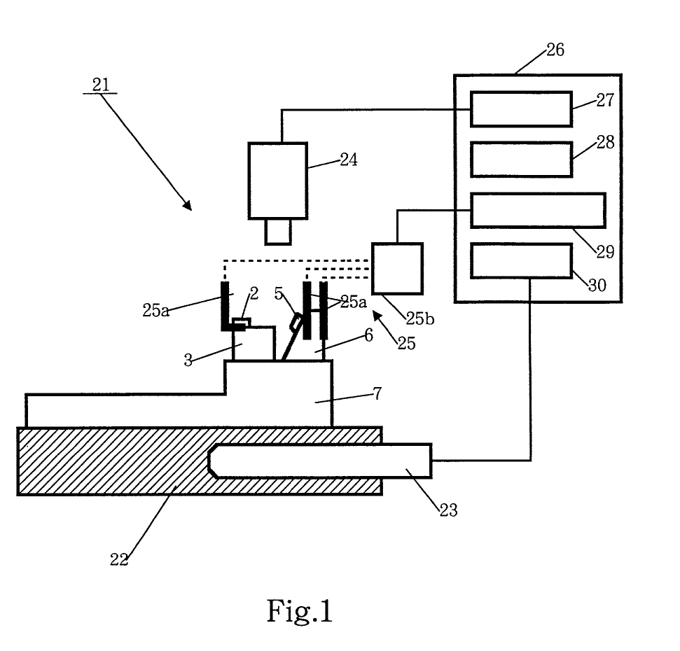

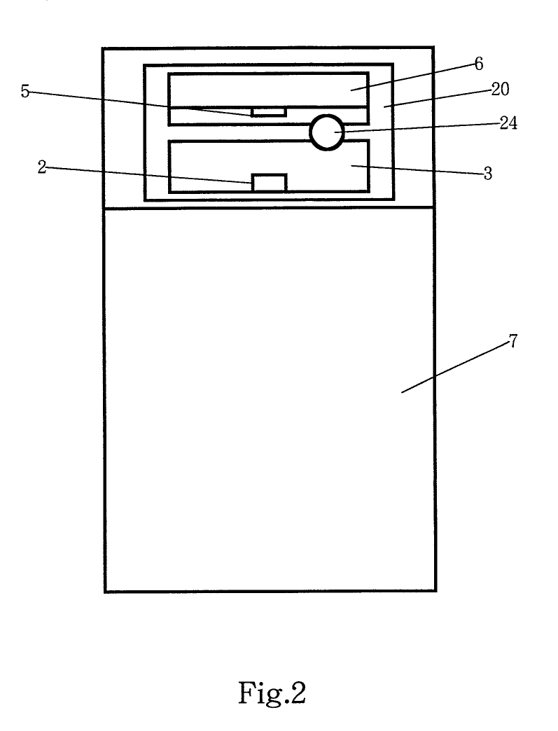

One embodiment of the present invention will be described with reference to the drawings. FIG. 1 is a side view illustrating a method of assembling a semiconductor laser module according to the present invention while FIG. 2 is a top view illustrating the same method.

Referring to FIG. 1, the method of assembling a semiconductor laser module according to the present invention uses a carrier fixing device 21 for soldering and fixing a second carrier 6 onto a base 7, the second carrier 6 fixedly supporting a first carrier 3 on which a semiconductor laser element 2 is fixedly mounted and a photodiode 5.

The carrier fixing device 21 comprises a plate 22 on which the base 7 to be heated is placed, a heating portion or heater 23 located on the plate 22 and adapted to heat a solder 20 deposited on the base 7, a photographing or CCD camera unit 24 for photographing the solder 20 heated by the heating portion 23, a scrubbing portion 25 for scrubbing the first and second carriers 3, 6, and a control unit 26 for controlling the heating portion 23, photographing unit 24 and scrubbing portion 25.

The scrubbing portion 25 comprising hands 23 for grasping the first and second carriers 3, 6 and a motor 25b for driving the hands 25a.

The photographing unit 24 is preferably to photograph an area adjacent to the junction between the first and second carriers 3, 6 and the base 7. For example, the photographing unit 24 may be located above the clearance between the first and second carriers 3, 6 (see FIG. 2) to photograph the solder 20. The placement of the photographing unit 24 is not limited to such a location.

The control unit 26 comprises an image processing section 27 for processing data relating to the solder 20 photographed by the photographing unit 24 to create image data, a detecting section 28 for detecting the state of fused solder 20 based on the image data created by the image processing section 27, a scrub control section 29 for energizing the motor 25b for the scrubbing portion 25 based on the state of fused solder 20 detected by the detecting section 28, and a temperature control section 30 for controlling the set temperature at the heating portion 23.

Usually, as the paste-like solder 20 is thermally fused into liquid phase, the photographing unit 24 provides an image in which the solder 20 has been changed from white-color to black-color. The image processing section 27 creates the image data by calculating the changed color of the solder 20 as a color signal level. If the color signal level in the created image data reaches a predetermined level, the detecting section 28 judges that the solder 20 has been fused. Such ajudgment may be performed based on other information such as brightness or shape, rather than the color signal.

In order to fuse the interior of the solder 20 into the sufficient degree of fusion, the detecting section 28 may judge the fused state of the solder 20 after a preselected time period (e.g., several seconds to several tens seconds) counted from when the detecting section 28 detects the color change on the image of the solder 20.

A method of assembling a semiconductor laser module of the present invention using the aforementioned carrier fixing device 21 will be described.

First of all, a semiconductor laser element 2 is fixedly mounted on the first carrier 3 in place. Subsequently, a photodiode 5 is fixedly mounted on the second carrier 6 in place.

The bottoms of the first and second carriers 3, 6 to be joined with the base 7 are plated with Au. The top of the base 7 is also plated with Au.

The solder 20 such as Au—Sn or the like is then supplied onto the top of the base 7 which has been placed on the plate 22.

Next, the first and second carriers 3, 6 are properly positioned on the base 7 in contact. Thereafter, the base 7 is heated by the heating portion 23 up to a temperature set by the temperature control section 30 of the control unit 26 to fuse the solder 20. The fused solder 20 is then photographed by the photographing unit 24.

The data relating to the solder 20 photographed by the photographing unit 24 is processed by the image processing section 27 to create an image data relating to a color signal level. The image data is then inputted into the detecting section 28 which in turn detects the fused state of the solder 20 based on the image data.

The scrub control section 29 energizes the motor 25b in the scrubbing portion 25 at the optimal timing based on the fused state of the solder 20 detected by the detecting section 28. Thus, the hands 25a grasping the first and second carriers 3, 6 are swung to perform the scrubbing. More particularly, the oxide film on the solder 20 is removed and the solder 20 is spread to position and fix it.

The subsequent steps are omitted since they are similar to those of the related art.

According to the present invention, the state of the fused solder 20 is detected through the image processing and then used to perform the scrubbing. Therefore, the scrubbing can be performed at the optimal timing whereat the solder 20 is fused from the paste state thereof into liquid phase. As a result, the first carrier 3 on which the semiconductor laser element 2 is fixedly mounted as well as the second carrier 6 on which the photodiode 5 is fixedly mounted can be soldered onto the base 7 in the stable and better manner. This improves the optical module in quality and reliability.

The present invention is not limited to the aforementioned embodiment, but may be carried out in any of various other forms without departing from the spirit and scope of the invention as defined by the appending claims. For example, the first and second carriers 3, 6 may be scrubbed and fixed simultaneously or sequentially.

1. A method of assembling an optical module comprising a carrier on which an optical element is fixedly mounted and a base on which said carrier is fixedly soldered, comprising the steps of:
depositing a solder on said base;
placing said carrier on said solder;
heating and photographing said solder;
detecting the state of fused solder from the image data of said photographed solder; and
scrubbing said carrier based on the detected state of the fused solder.

2. An optical module comprising a carrier on which an optical element is fixedly mounted and a base on which said carrier is fixedly soldered, said optical module being made by:
depositing a solder on said base;
placing said carrier on said solder;
heating and photographing said solder;
detecting the state of fused solder from the image data of said photographed solder; and
scrubbing said carrier based on the detected state of the fused solder.

3. An apparatus for assembling an optical module comprising a carrier on which an optical element is fixedly mounted and a base on which said carrier is fixedly soldered, comprising:
a heating section for heating a solder on said base;
a photographing section for photographing the solder on said base;
a scrubbing section for scrubbing the carrier on which the optical element is fixedly mounted in the fused state of the solder on said base; and
a detecting section for detecting the state of the fused solder from the image data of the solder photographed by said photographing section.
